(19) United States
(12) Patent Application Publication
(10) Pub. No.: US 2019/0307649 A1
(43) Pub. Date: Oct. 10, 2019

(54) PERCUTANEOUS ENDOSCOPIC GASTROSTOMY (PEG) TUBE HAVING AN IMPROVED INTERNAL BUMPER

(71) Applicant: THE UAB RESEARCH FOUNDATION, Birmingham, AL (US)

(72) Inventors: Derek Van Vessem, Tallahassee, FL (US); Kaitlyn Ryan, Birmingham, AL (US); Isaac Shamblin, Birmingham, AL (US)

(21) Appl. No.: 16/376,227

(22) Filed: Apr. 5, 2019

Related U.S. Application Data
(60) Provisional application No. 62/653,176, filed on Apr. 5, 2018.

(51) Int. Cl. A61J 15/00

(52) U.S. Cl. CPC A61J 15/0019; A61J 15/0092; A61J 15/0038

(57) ABSTRACT

A PEG tube having a new internal bumper design is provided that prevents, or at least reduces the chances of, unintended dislodgement of the PEG tube. The internal bumper is disposed on a proximal end of the tubing of the PEG tube and is in a first, placed state when the PEG tube is in a feeding position inside of a patient. In the first, placed state, the internal bumper is a substantially solid structure having a preselected shape and a preselected maximum outer diameter or width. Initiation of a removal process converts the internal bumper from the first, placed state to a second, removal state in which the internal bumper is a generally elongated structure that has an outer diameter or width that is smaller than the maximum outer diameter or width. The smaller diameter or width of the generally elongated structure facilitates withdrawal of the generally elongated structure through the tract in the patient's stomach.

### CROSS-REFERENCE TO RELATED APPLICATIONS

The present application is a nonprovisional application that claims the benefit of and priority to the filing date of U.S. provisional application Ser. No. 62/653,176, filed on Apr. 5, 2018 and entitled “CONFORMATION CHANGING PERCUTANEOUS ENDOSCOPIC GASTROSTOMY TUBE,” which is hereby incorporated by reference herein in its entirety.

### GOVERNMENT SUPPORT

The invention was made with Government support under Contract/Grant No. R25HD078327 awarded by the National Institutes of Health (NIH) and under Contract/Grant No. 1263941 awarded by the National Science Foundation (NSF). The Government has certain rights in the invention.

### TECHNICAL FIELD OF THE INVENTION

This invention relates to percutaneous endoscopic gastrostomy (PEG) tubes, and in particular, to a PEG tube having an improved internal bumper that reduces the chance of the tube accidentally being pulled out or dislodged.

### BACKGROUND OF THE INVENTION

PEG tubes are placed in patients who are not able to ingest food down the esophagus and provide feed to the patient directly into the stomach, preventing malnutrition. These are usually trauma, stroke, head or neck cancer patients going through chemotherapy, and young patients who have trouble swallowing. Today there are two main styles of device being used commercially with two different internal bumper designs and insertion methods. There are mushroom internal bumpers inserted using the pull method and balloon internal bumpers inserted using the push method and inflated inside the stomach.

The tubes are prone to being pulled out or dislodged from the patient, leading to infection and additional surgeries. Approximately 216,000 PEG tubes were placed in the year 2000, and that number will grow with growth of the elderly population. The PEG tube can be placed in a patient in an operating room under either local or general anesthesia or in an outpatient setting. The two methods that are commonly used for placing the PEG tube are the pull method and the push method, with the pull method being the most common method used for PEG tube insertion. The pull method is illustrated in FIGS. 1A-1E. An endoscope 2 is placed and travels down the esophagus into the patient's stomach. A light on the end of the endoscope is turned on and the lights in the room are dimmed. The light allows the user to observe that there are not any other organs, specifically the colon, in between the abdominal wall and the stomach. A catheter 3 with a wire 4 inside is used to puncture the patient's abdomen and the wire 4 is pushed into the stomach then pulled up the esophagus by the endoscope (FIG. 1A). The wire 4 is now coming out of the patient's stomach and mouth (FIG. 1B). The wire 4 coming out of the mouth is attached to the feeding tube 6 (FIG. 1C) and pulled at the other end to pull the tube down the throat and out through the stomach (FIG. 1D) until the internal bumper 7 is in contact with the anterior wall of the stomach (FIG. 1E).

A PEG tube can also be placed using the push method where the tube and internal bumper are pushed through an incision site in the stomach of the patient. This method commonly uses balloon bumpers instead of the mushroom bumpers used in the pull method.

Regardless of the insertion method used, the tubes are designed to be pulled out as early as one month after being inserted, but unruly patients or nurses who are moving patients can pull out the tubes prematurely. The hole in the patient's stomach that hardens around the tube (similar to an earring hole) is referred to as a tract. Typically, tracts would take about one week to mature and harden, but can take up to three weeks in these patients because they were previously malnourished causing slower wound healing. If a tube is removed once the tract is formed after three to four weeks, a Foley catheter can be used to keep the tract open. If the tract has not formed yet, a new tube will be placed in a different location and the old tract will heal in approximately 24-48 hours. Re-insertion of a new tube involves another surgical procedure costing approximately $20,000.

The internal bumper, when pulled too hard against the stomach wall, can migrate into the gastric wall and epithelial layer of the abdominal wall causing buried bumper syndrome (BBS). Many times this disease is not caught until months or years after PEG tube placement. This problem has lessened with new softer bumpers being used, as data has shown that harder plastic bumpers increase the rates of BBS. If this occurs, the tube will have to be removed in surgery and a new tube will be placed in a different spot while the old tract heals. Any pulling on the tube can lead to feed coming in contact with the abdominal wall or skin and can cause infection as the food seeps into the abdominal space. Infection from the feed can cause many different health problems, including death. Statistics show that approximately 7.8% of the patients who receive PEG tubes die from complications. Minor complications, including tube dislodgement, occur in as many as 88% of patients.

A need exists for a PEG tube that prevents or reduces the possibility of dislodgement and therefore prevents or reduces the likelihood of patients having to undergo additional surgeries and additional pain.

### SUMMARY

Representative embodiment in accordance with the inventive principles and concepts are directed to a PEG tube comprising PEG tubing and an internal bumper. The PEG tubing has a proximal end and a distal end. The internal bumper is disposed on the proximal end of the PEG tubing. The internal bumper is in a first, placed state when the PEG tube is in a feeding position inside of a patient. In the first, placed state, the internal bumper is a substantially solid structure having a preselected shape and a preselected maximum outer diameter or width. Initiation of a removal process converts the internal bumper from the first, placed state to a second, removal state in which the internal bumper is converted into a generally elongated structure that has an outer diameter or width that is smaller than the maximum outer diameter or width when it is in the first, placed state to facilitate withdrawal of the generally elongated structure through a tract in the patient's stomach through which the PEG tubing extends when the PEG tube is in the feeding position.

In accordance with a representative embodiment, initiation of the removal process is performed by actuating a conversion mechanism that cuts a preselected pattern in the internal bumper to thereby convert the internal bumper from the first, placed state to the second, removal state.

In accordance with a representative embodiment, the conversion mechanism comprises a wire or cord having a proximal end, a distal end and a length of wire or cord extending from the proximal end to the distal end of the wire or cord. A portion of wire or cord near the proximal end of the wire or cord is embedded in the material comprising the internal bumper in a preselected pattern. The distal end of the wire or cord extends out of the distal end of the PEG tubing. The wire or cord is actuated by pulling on the distal end of the wire or cord to cause the portion of the wire or cord that is embedded in the material to cut through the material to convert the internal bumper into the generally elongated structure.

These and other features and advantages will become apparent from the following description, drawings and claims.

### BRIEF DESCRIPTION OF THE DRAWINGS

FIGS. 1A-1E illustrate the pull method commonly used to place a PEG tube in a patient of the type that includes a mushroom internal bumper.

FIG. 2A is a side elevation view of a PEG tube in accordance with a representative embodiment.

FIG. 2B is a top plan view of the PEG tube shown in FIG. 2A in accordance with a representative embodiment.

FIG. 2C is a side cross-sectional view of one-halve of the internal bumper of the PEG tube contained in the dashed box 12 shown in FIG. 2A.

FIGS. 3A, 3B and 3C show bottom perspective, side plan and top plan views, respectively, of a prototype of the PEG tube having the features described with reference to FIGS. 2A-2C.

### DETAILED DESCRIPTION OF AN ILLUSTRATIVE EMBODIMENT

In accordance with the inventive concepts and principles, a new internal bumper design is provided that prevents, or at least reduces the chances of, unintended dislodgement of the PEG tubes, thereby limiting complications associated therewith. The PEG tube comprises PEG tubing and an internal bumper. The PEG tubing has a proximal end and a distal end. The internal bumper is disposed on the proximal end of the PEG tubing. The internal bumper is in a first, placed state when the PEG tube is in a feeding position inside of a patient. In the first, placed state, the internal bumper is a substantially solid structure having a preselected shape and a preselected maximum outer diameter or width. Initiation of a removal process converts the internal bumper from the first, placed state to a second, removal state in which the internal bumper is converted into a generally elongated structure that has an outer diameter or width that is smaller than the maximum outer diameter or width when it is in the first, placed state to facilitate withdrawal of the generally elongated structure through a tract in the patient's stomach through which the PEG tubing extends when the PEG tube is in the feeding position.

In the following detailed description, a few illustrative, or representative, embodiments are described to demonstrate the inventive principles and concepts. For purposes of explanation and not limitation, representative embodiments disclosing specific details are set forth in order to provide a thorough understanding of an embodiment according to the present teachings. However, it will be apparent to one of ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

The terminology used herein is for purposes of describing particular embodiments only, and is not intended to be limiting. As used in the specification and appended claims, the terms “a,” “an,” and “the” include both singular and plural referents, unless the context clearly dictates otherwise. Thus, for example, “a device” includes one device and plural devices. Relative terms may be used to describe the various elements' relationships to one another, as illustrated in the accompanying drawings. These relative terms are intended to encompass different orientations of the device and/or elements in addition to the orientation depicted in the drawings. It will be understood that when an element is referred to as being “connected to” or “coupled to” another element, it can be directly connected or coupled, or intervening elements may be present.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

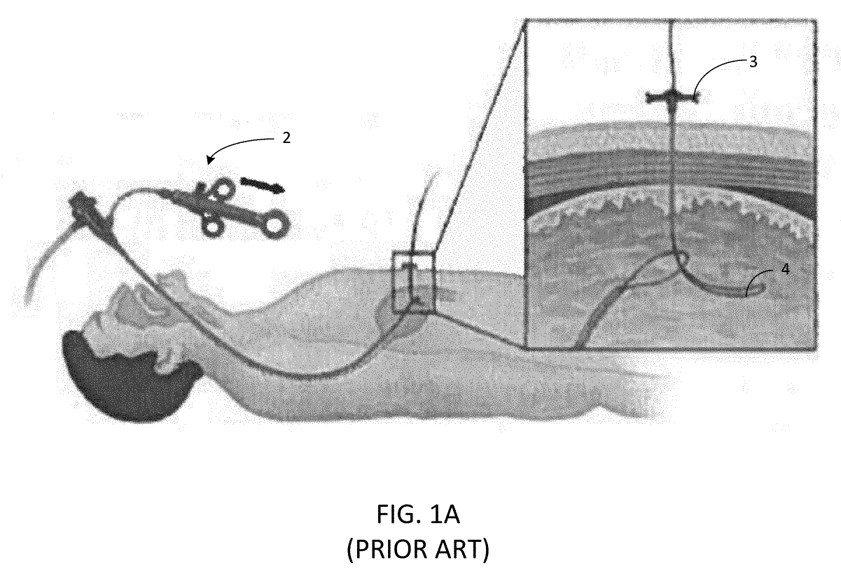

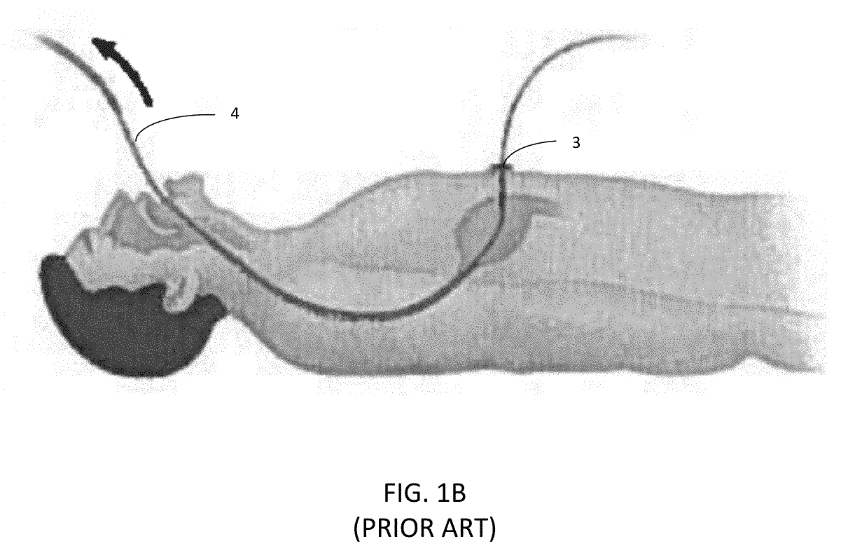

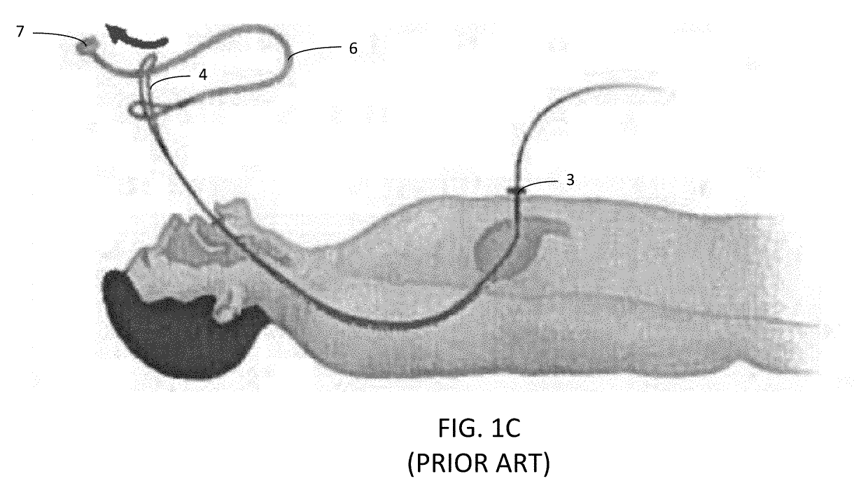

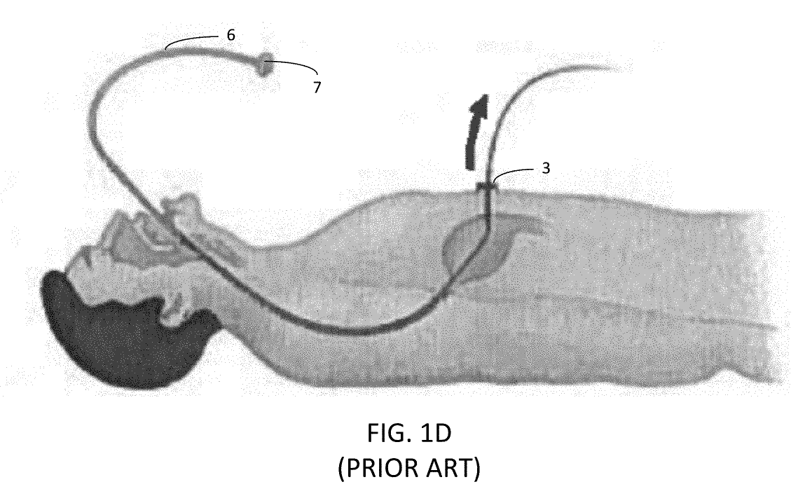

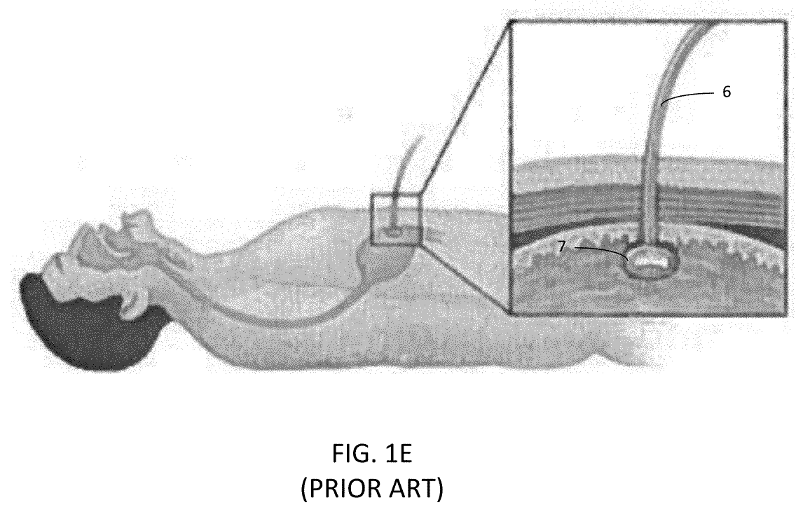

In accordance with a representative embodiment, the internal bumper is generally disk-shaped and adapted to be inserted into the patient using an endoscope via the pull method described above with reference to FIGS. 1A-1E. This disk-shaped internal bumper preferably is larger in size and more rigid than known internal bumpers of the type described above to provide sufficient tension and hold to prevent the internal bumper from accidently becoming dislodged due to external forces exerted on the exterior of the tubing of the PEG tube. When it is time for the PEG tube to be removed, the preferred configuration of the internal bumper allows it to be easily pulled out through the tract in the stomach.

Currently, known PEG tubes are removed solely by pulling the tube out through the tract in the stomach, which can lead to accidental premature dislodgement and pain to the patient. In accordance with a representative, or illustrative, embodiment, the internal bumper is removed by pulling a cord or wire when the internal bumper needs to be removed. As this cord is pulled, it cuts around the disk-shaped internal bumper in a spiral resulting in a corkscrew-shaped piece of bumper material (e.g., silicone) attached to the end of the tubing. The outer diameter of the corkscrew-shaped piece of bumper material is smaller than the diameter of the tract in the stomach formed by the PEG tube to allow the tube with the corkscrew-shaped piece of bumper material attached to the end of it to be easily pulled through the tract without risking complications, such as BBS, for example.

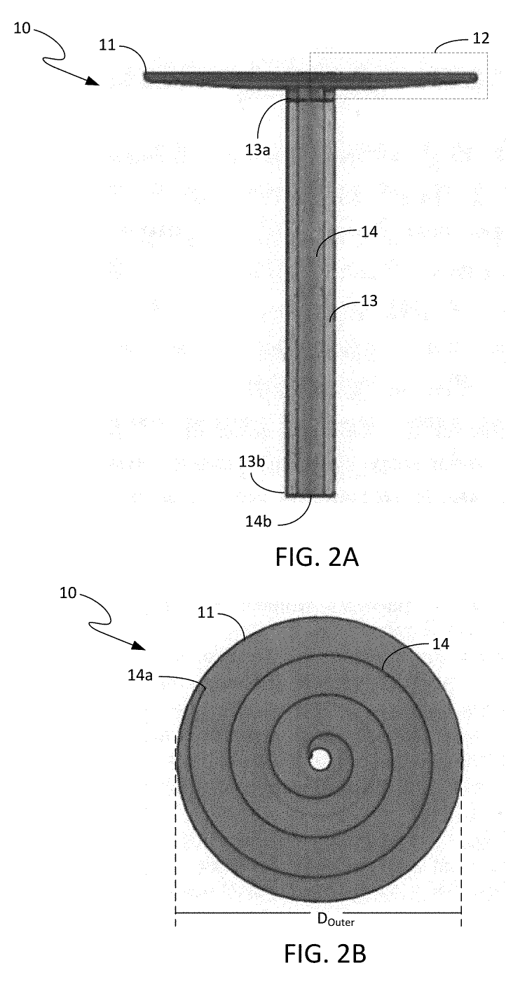

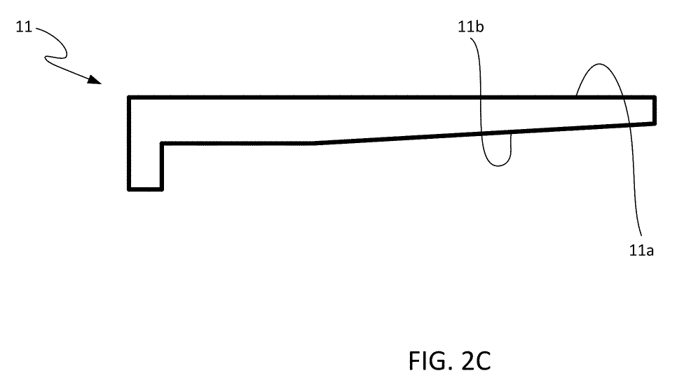

FIG. 2A is a side elevation view of the PEG tube 10 in accordance with a representative embodiment. FIG. 2B is a top plan view of the PEG tube 10 in accordance with a representative embodiment. FIG. 2C is a side cross-sectional view of the one-halve of the internal bumper 11 of the PEG tube 10 contained in the dashed box 12 shown in FIG. 2A. The internal bumper 11 is disposed on a proximal end 14a of the tubing 13 of the PEG tube 10. As indicated above, in accordance with a representative embodiment, the internal bumper 11 is disk-shaped and preferably is larger in size and more rigid than known mushroom internal bumpers of the type described above to prevent the internal bumper 11 from accidently becoming dislodged due to external forces exerted on the exterior of the tubing of the PEG tube 10.

The tubing 13 of the PEG tune 10 and the internal bumper 11 may be integrally formed of a suitable material, such as, for example, silicone or latex. A suitable process, such as injection molding, for example, may be used to manufacture the PEG tube 10 with the internal bumper 11 integrally formed on the proximal end 13a of the tubing 13. Alternatively, the tubing 13 and the internal bumper 11 may be manufactured as separate parts and subsequently secured to one another by a suitable process and/or material (e.g., glue or other type of adhesive, plastic welding, etc.). The PEG tube 10 is not limited to being made of any particular material or by any particular process, as will be understood by those of skill in the art in view of the description provided herein.

In accordance with this representative embodiment, a thin wire or cord 14 of a suitable material (e.g., medical grade metal that will not degrade inside of the human body), is embedded in the material comprising the internal bumper 11 and arranged in a suitable pattern, which is a spiral pattern in accordance with the representative embodiment shown in FIG. 2B. The wire or cord acts as a conversion mechanism that converts the internal bumper 11 from the aforementioned first, placed state to a second, removal state in which the internal bumper is converted into a generally elongated structure that has an outer diameter or width that is smaller than the maximum outer diameter or width when it is in the first, placed state to facilitate withdrawal of the generally elongated structure through a tract in the patient's stomach through which the PEG tubing extends when the PEG tube is in the feeding position.

The proximal end 14a (FIG. 2B) of the cord or wire 14 is embedded in the material comprising the internal bumper 11. The distal end 14b (FIG. 2A) of the cord or wire 14 extends out of the distal end 13b of the tubing 13.

With reference to FIG. 2C, the internal bumper 11 preferably is generally disk-shaped having a top substantially planar surface 11a and a bottom tapered surface 11b. The bottom tapered surface 11b results in the profile of the internal bumper 11 being thinner as it approaches the outer edges of the internal bumper 11 and thicker toward the center of the internal bumper 11. This thinning of the profile as it approaches the outer edges of the internal bumper 11 gives the internal bumper 11 some flexibility that allows some forces to be exerted on the tubing 13 by a healthcare worker or patient without causing the PEG tube 10 to become dislodged. The internal bumper 11 has a maximum outer diameter, D_{Outer}, that ranges from about 10 millimeters (mm) to about 60 mm. Preferably, D_{Outer} ranges from about 25 mm to about 50 mm.

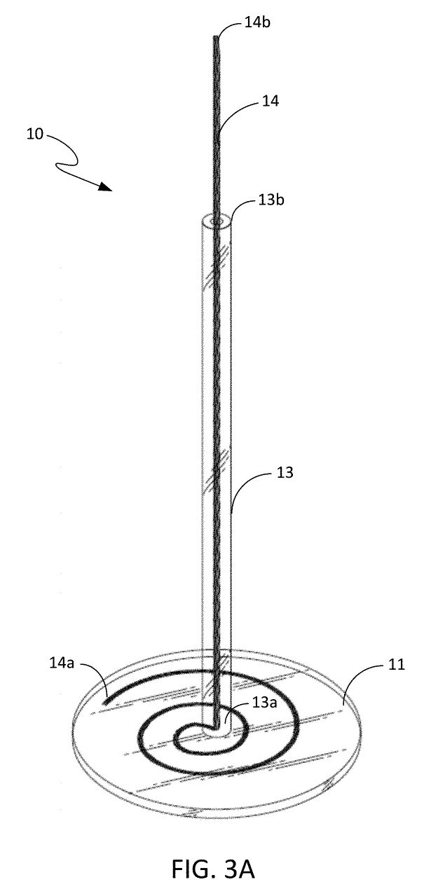

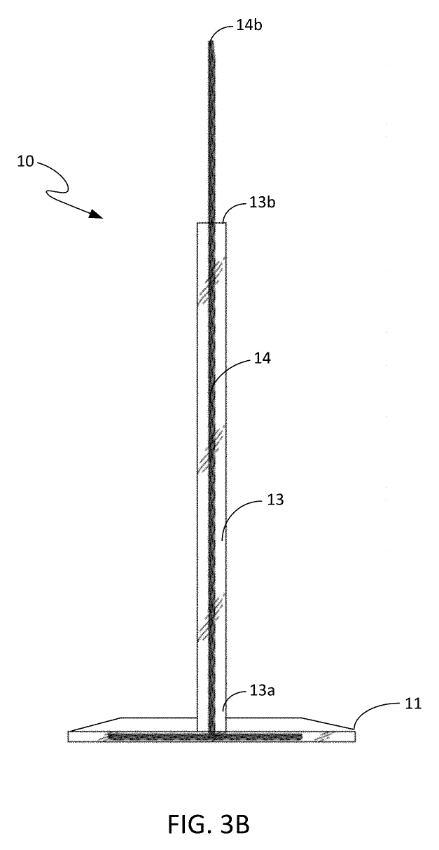

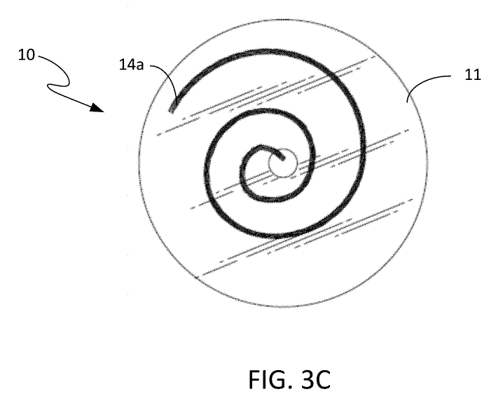

FIGS. 3A, 3B and 3C show bottom perspective, side plan and top plan views, respectively, of a prototype of the PEG tube 10 having the features described with reference to FIGS. 2A-2C. The prototype PEG tube 10 was designed with the wire or cord 14 extending along the passageway of the tubing 13 through which the feed passes, but the wire or cord 14 could instead be embedded in the side walls of the tubing 13. Alternatively, the wire or cord 14 can be secured to the outside wall of the tubing 13.

In order to intentionally remove the PEG tuber 10, the person performing the removal process grasps the distal end 14b of the wire or cord 14 extending out of the distal end 13b of the tubing 13 and pulls it. As this wire or cord 14 is pulled, it cuts around the internal bumper 11 in the spiral pattern in which the wire or cord 14 is arranged in the material comprising the internal bumper 11. This act of pulling on the wire or cord 14 causes it to cut through the material comprising the internal bumper 11 at the locations in the material in which the wire or cord 14 is disposed, resulting in a corkscrew-shaped piece of bumper material (e.g., silicone) attached to the end of the tubing 13. The outer diameter of the corkscrew-shaped piece of bumper material is smaller than the diameter of the tract in the stomach formed by the PEG tube to allow the tube with the corkscrew-shaped piece of bumper material attached to the end of it to be easily pulled through the tract without risking complications, such as BBS, for example.

It should be noted that the internal bumper 11 may have shapes other than the shape of a disk, as will be understood by those of skill in the art in view of the description provided herein. The internal bumper is generally a solid structure that has a desired characteristics of flexibility and rigidity that allow the tubing to be handled without accidentally disengaging the bumper. The desired characteristics of flexibility and rigidity can be achieved by selecting a material (e.g., silicone) and process for forming the bumper (e.g., injection molding) that provide a structure that has the desired degrees of flexibility and rigidity. For example, selecting a less flexible silicone, forming a thicker bumper structure and/or treating the silicone with one or more chemicals that change its characteristics through one or more chemical reactions are ways of achieving the desired flexibility and rigidity.

Regardless of the shape and size of the internal bumper or the materials and processes that are used to manufacture, it will have a first, placed state after the PEG tube has been placed in a feeding position inside of the patient via the pull method, and it will have a second, removal state when a person or machine is performing the process of removing the PEG tube. In the first, placed state, the internal bumper is fully deployed and is at its maximum size (e.g., maximum outer diameter or width) against the anterior wall of the stomach. In the second, removal state, the internal bumper has been converted into a generally elongated structure having an outer diameter or width that is smaller than the maximum outer diameter or width to facilitate withdrawal of the generally elongated structure through the tract.

It should be noted that illustrative embodiments have been described herein for the purpose of demonstrating principles and concepts of the invention. As will be understood by persons of skill in the art in view of the description provided herein, many modifications may be made to the embodiments described herein without deviating from the scope of the invention. For example, while the inventive principles and concepts have been described with reference to the internal bumper shown in FIGS. 2A-3C, the inventive principles and concepts are equally applicable to other configurations. For example, while the spiral pattern shown in FIG. 3C is one possible pattern for the wire or cord, other patterns are possible, such as grid patterns and zig-zag patterns that can cut through and unravel the material comprising the internal bumper. Also, many modifications may be made to the embodiments described herein without deviating from the inventive principles and concepts, and all such modifications are within the scope of the invention, as will be understood by those of skill in the art.

What is claimed is:

1. A percutaneous endoscopic gastrostomy (PEG) tube comprising:
PEG tubing having a proximal end and a distal end; and
an internal bumper disposed on the proximal end of the PEG tubing, the internal bumper being in a first, placed state when the PEG tube is in a feeding position inside of a patient, wherein in the first, placed state the internal bumper is a substantially solid structure having a preselected shape and a preselected maximum outer diameter or width, and wherein initiation of a removal process converts the internal bumper from the first, placed state to a second, removal state in which the internal bumper is in a generally elongated structure that has an outer diameter or width that is smaller than said maximum outer diameter or width to facilitate withdrawal of the generally elongated structure through a tract in the patient's stomach through which the PEG tubing extends when the PEG tube is in the feeding position.

2. The PEG tube of claim 1, wherein the preselected shape of the internal bumper is generally disk-shaped when the internal bumper is in the first, placed state.

3. The PEG tube of claim 1, wherein initiation of the removal process is performed by actuating a conversion mechanism that cuts a preselected pattern in the internal bumper to thereby convert the internal bumper from the first, placed state to the second, removal state.

4. The PEG tube of claim 3, wherein the conversion mechanism comprises a wire or cord having a proximal end, a distal end and a length of wire or cord extending from the proximal end of the wire or cord to the distal end of the wire or cord, and wherein a portion of wire or cord near the proximal end of the wire or cord is embedded in a material comprising the internal bumper in a preselected pattern, the distal end of the wire or cord extending out of the distal end of the PEG tubing, the wire or cord being actuated by pulling on the distal end of the wire or cord to cause the portion of the wire or cord that is embedded in the material to cut through the material to convert the internal bumper into the generally elongated structure.

5. The PEG tube of claim 4, wherein the preselected pattern of the portion of wire or cord embedded in the material is a spiral pattern.

6. The PEG tube of claim 1, wherein the internal bumper has a maximum outer diameter or width that ranges from about 10 millimeters (mm) to about 60 mm.

7. The PEG tube of claim 6, wherein the internal bumper has a maximum outer diameter or width that ranges from about 25 mm to about 50 mm.

8. The PEG tube of claim 1, wherein the PEG tubing and the internal bumper are integrally formed as a unitary piece part.

9. The PEG tube of claim 1, wherein the PEG tubing and the internal bumper are separate piece parts that are connected to one another.

10. The PEG tube of claim 2, wherein the generally disk-shaped internal bumper decreases in thickness in a direction away from a center of the internal bumper toward a peripheral edge of the internal bumper, and wherein the decreased thickness provides the internal bumper with preselected flexibility and rigidity characteristics that reduce the likelihood of accidental dislodgment of the internal bumper when the PEG tube is in the feeding position inside of the patient.

11. The PEG tube of claim 1, wherein the PEG tube is adapted to be placed in the feeding position inside of the patient using a pull method.

12. A percutaneous endoscopic gastrostomy (PEG) tube comprising:
PEG tubing having a proximal end and a distal end;
an internal bumper disposed on the proximal end of the PEG tubing, the internal bumper being in a first, placed state when the PEG tube is in a feeding position inside of a patient, wherein in the first, placed state the internal bumper is generally disk-shaped and has a preselected maximum outer diameter, and wherein initiation of a removal process converts the internal bumper from the first, placed state to a second, removal state in which the internal bumper is a generally elongated structure that has an outer diameter that is smaller than said maximum outer diameter to facilitate withdrawal of the generally elongated structure through a tract in the patient's stomach through which the PEG tubing extends when the PEG tube is in the feeding position; and
a wire or cord having a proximal end, a distal end and a length of wire or cord extending from the proximal end of the wire or cord to the distal end of the wire or cord, and wherein a portion of wire or cord near the proximal end of the wire or cord is embedded in material comprising the internal bumper in a preselected pattern, the distal end of the wire or cord extending out of the distal end of the PEG tubing, wherein initiation of the removal process is performed by pulling on the distal end of the wire or cord to cause the portion of the wire or cord that is embedded in the material to cut through the material to convert the internal bumper into the generally elongated structure.

13. The PEG tube of claim 12, wherein the preselected pattern of the portion of wire or cord embedded in the material is a spiral pattern.

14. The PEG tube of claim 12, wherein the internal bumper has a maximum outer diameter that ranges from about 10 millimeters (mm) to about 60 mm.

15. The PEG tube of claim 13, wherein the internal bumper has a maximum outer diameter that ranges from about 25 mm to about 50 mm.

16. The PEG tube of claim 12, wherein the PEG tubing and the internal bumper are integrally formed as a unitary piece part.

17. The PEG tube of claim 12, wherein the PEG tubing and the internal bumper are separate piece parts that are connected to one another.

18. The PEG tube of claim 12, wherein the generally disk-shaped internal bumper decreases in thickness in a direction away from a center of the internal bumper toward a peripheral edge of the internal bumper, and wherein the decreased thickness provides the internal bumper with preselected flexibility and rigidity characteristics that reduce the likelihood of accidental dislodgment of the internal bumper when the PEG tube is in the feeding position inside of the patient.

19. A method of placing a percutaneous endoscopic gastrostomy (PEG) tube inside of a patient, the method comprising:
using a pull method to place the PEG tube in a feeding position inside of the patient, the PEG tube comprising PEG tubing having a proximal end and a distal end and having an internal bumper secured to the proximal end of the PEG tubing, the internal bumper being in a first, placed state when the PEG tube is in the feeding position inside of the patient, wherein the internal bumper is in contact with an anterior wall of the patient's stomach in the first, placed state and has a substantially solid structure with a preselected shape and a preselected maximum outer diameter or width, and wherein initiation of a removal process to remove the PEG tube from the patient converts the internal bumper from the first, placed state to a second, removal state in which the internal bumper is in a generally elongated structure that has an outer diameter or width that is smaller than said maximum outer diameter or width to facilitate withdrawal of the generally elongated structure through a tract in the patient's stomach through which the PEG tubing extends when the PEG tube is in the feeding position.

20. The method of claim 19, wherein the PEG tube comprises a wire or cord having a proximal end, a distal end and a length of wire or cord extending from the proximal end of the wire or cord to the distal end of the wire or cord, and wherein a portion of wire or cord near the proximal end of the wire or cord is embedded in a material comprising the internal bumper in a preselected pattern, the distal end of the wire or cord extending out of the distal end of the PEG tubing, wherein initiation of the removal process is performed by pulling on the distal end of the wire or cord to cause the portion of the wire or cord that is embedded in the material to cut through the material to convert the internal bumper into the generally elongated structure.
